(19) United States
(12) Patent Application Publication
(10) Pub. No.: US 2018/0206109 A1
(43) Pub. Date: Jul. 19, 2018

(54) INTELLIGENT SUBSCRIPTION SELECTION FOR POSITIONING

(71) Applicant: QUALCOMM Incorporated, San Diego, CA (US)

(72) Inventors: Suresh Kumar BITRA, Mangalagiri (IN); Arun Kumar Sharma TANDRA, Hyderabad (IN); Ashwin Kumar DONTHULA, Hyberabad (IN)

(21) Appl. No.: 15/406,186

(22) Filed: Jan. 13, 2017

(51) Int. Cl. H04W 8/18; H04W 4/02; H04W 48/18; H04W 4/22

(52) U.S. Cl. CPC H04W 8/183; H04W 4/22; H04W 48/18; H04W 4/02

(57) ABSTRACT

An example of a method for operating a user equipment (UE) including a first subscriber identity module (SIM) and a second SIM includes determining that a quality of first positioning assistance data associated with the first SIM is greater than a quality of second positioning assistance data associated with the second SIM; and performing an action using the first SIM in response to determining that the quality of first positioning assistance data associated with the first SIM is greater than the quality of second positioning assistance data associated with the second SIM.

### BACKGROUND

A User Equipment (UE)—such as a cellular phone, smart phone, tablet computer, laptop computer, smart watch, and other mobile device—may include multiple subscriber identity modules (SIM) and therefore allow the UE to communicate via multiple subscriptions to different corresponding wireless networks. A UE with multiple SIMs is referred to as a “multi-SIM device.” Each SIM of a UE is associated with a respective subscription with a carrier, e.g., a paid-for agreement, which gives the UE access to a network associated with the carrier and enables the sending and receiving of multimedia data and voice information. Each SIM stores subscription information that is used by the UE to authenticate the SIM on the respective wireless network. A multi-SIM device where the multiple SIMs share a transceiver for communicating with their respective networks is referred to as a “multi-SIM-multi-standby device.” An example is a UE with two SIMs and a single transceiver, referred to as a “dual-SIM-dual-standby (DSDS) device.” A multi-SIM device where each of the multiple SIMs has its own dedicated transceiver for communicating with their respective networks is referred to as a “multi-SIM-multi-active device.” An example is a UE with two SIMs and two transceivers, one dedicated to each SIM, is referred to as a “dual-SIM-dual-active (DSDA) device.”

In addition to sending and receiving multimedia data and voice information with a wireless network, a UE may also be configured to perform positioning techniques to determine the location of the UE. For example, multilateration techniques may be used to determine the location of the UE. To perform multilateration, the UE receives and analyzes positioning signals from multiple signal emitters located at known locations. In some positioning techniques, the base stations of the wireless networks with which the UE communicates emit the signals used for positioning. One example of a positioning technique that uses multilateration is Observed Time Difference Of Arrival (OTDOA), which uses measurements of the difference in arrival times of positioning signals (e.g., positioning reference signals (PRS)) received by the UE from the multiple base stations. A multi-SIM device may perform OTDOA using any of the available subscriptions.

In order to perform OTDOA, or other positioning techniques, the location of the emitters and other information about the PRS are used. This information is provided to the UE in the form of assistance data. Assistance data may be sent from a serving base station to the UE from a location server associated with the network, or the assistance data may be received from a third party server. A multi-SIM device receives assistance data for a first network associated with a first SIM and a second network associated with a second SIM.

### SUMMARY

An example of a method for operating a user equipment (UE) including a first subscriber identity module (SIM) and a second SIM includes determining that a quality of first positioning assistance data associated with the first SIM is greater than a quality of second positioning assistance data associated with the second SIM; and performing an action using the first SIM in response to determining that the quality of first positioning assistance data associated with the first SIM is greater than the quality of second positioning assistance data associated with the second SIM.

Implementations of such a method may also, or alternatively, include one or more of the following features. The determining that a quality of first positioning assistance data associated with the first SIM is greater than a quality of second positioning assistance data associated with the second SIM may include comparing a first number of positioning techniques for which information is included in the first positioning assistance data and a second number of positioning techniques for which information is included in the second positioning assistance data. The determining that the quality of the first positioning assistance data associated with the first SIM is greater than the quality of the second positioning assistance data associated with the second SIM may include determining that the first number of positioning techniques is greater than the second number of positioning techniques.

Implementations of such a method may also, or alternatively, include one or more of the following features. The determining that a quality of first positioning assistance data associated with the first SIM is greater than a quality of second positioning assistance data associated with the second SIM may include comparing a first number of signal emitters for which information is included in the first positioning assistance data and a second number of signal emitters for which information is included in the second positioning assistance data. The determining that the quality of the first positioning assistance data associated with the first SIM is greater than the quality of the second positioning assistance data associated with the second SIM may include determining that the first number of signal emitters is greater than the second number of signal emitters.

Implementations of such a method may also, or alternatively, include one or more of the following features. The determining that a quality of first positioning assistance data associated with the first SIM is greater than a quality of second positioning assistance data associated with the second SIM may include comparing a first uncertainty value included in the first positioning assistance data and a second uncertainty value included in the second positioning assistance data. The first uncertainty value and the second uncertainty value each may include at least one of a location uncertainty of a location of a respective signal emitter or a timing uncertainty of a time of arrival of a respective signal.

Implementations of such a method may also, or alternatively, include one or more of the following features. The method may include determining, with a processor of the UE, a first indication of the quality of the first positioning assistance data; and determining, with the processor of the UE, a second indication of the quality of the second positioning assistance data. The method may include receiving, from a server, a first indication of the quality of the first positioning assistance data and a second indication of the quality of the second positioning assistance data. The performing the action using the first SIM may include placing a phone call using the first SIM. The placing the phone call using the first SIM may be done in response to receiving an indication from a user to place an emergency call. The performing the action using the first SIM may include measuring, using the first positioning assistance data, a parameter of each signal of a plurality of positioning signals for use in determining a location of the UE, the plurality of positioning signals being received from a respective signal emitter of a plurality of signal emitters.

An example of a user equipment (UE) includes a first subscriber identity module (SIM) associated with a first network; a second SIM associated with a second network; a transceiver configured to communicate with the first network using the first SIM and the second network using the second SIM; a processor, communicatively coupled to the transceiver, the first SIM and the second SIM. The processor is configured to determine that a quality of first positioning assistance data associated with the first SIM is greater than a quality of second positioning assistance data associated with the second SIM; and perform an action using the first SIM in response to determining that the quality of first positioning assistance data associated with the first SIM is greater than the quality of second positioning assistance data associated with the second SIM.

Implementations of such a UE may also, or alternatively, include one or more of the following features. The processor may be configured to determine that the quality of the first positioning assistance data associated with the first SIM is greater than the quality of the second positioning assistance data associated with the second SIM by comparing a first number of positioning techniques for which information is included in the first positioning assistance data and a second number of positioning techniques for which information is included in the second positioning assistance data. The processor may be configured to determine that the quality of the first positioning assistance data associated with the first SIM is greater than the quality of the second positioning assistance data associated with the second SIM by determining that the first number of positioning techniques is greater than the second number of positioning techniques.

Implementations of such a UE may also, or alternatively, include one or more of the following features. The processor may be configured to determine that the quality of the first positioning assistance data associated with the first SIM is greater than the quality of the second positioning assistance data associated with the second SIM by comparing a first number of signal emitters for which information is included in the first positioning assistance data and a second number of signal emitters for which information is included in the second positioning assistance data. The processor may be configured to determine that the quality of the first positioning assistance data associated with the first SIM is greater than the quality of the second positioning assistance data associated with the second SIM by determining that the first number of signal emitters is greater than the second number of signal emitters.

Implementations of such a UE may also, or alternatively, include one or more of the following features. The processor may be configured to determine that the quality of the first positioning assistance data associated with the first SIM is greater than the quality of the second positioning assistance data associated with the second SIM by determining that the first number of signal emitters is greater than the second number of signal emitters. The first uncertainty value and the second uncertainty value each comprise at least one of a location uncertainty of a location of a respective signal emitter or a timing uncertainty of a time of arrival of a respective signal.

Implementations of such a UE may also, or alternatively, include one or more of the following features. The processor may be further configured to determine a first indication of the quality of the first positioning assistance data; and determine a second indication of the quality of the second positioning assistance data. The processor may be further configured to receive, from a server, a first indication of the quality of the first positioning assistance data and a second indication of the quality of the second positioning assistance data. The processor may be configured to perform the action using the first SIM by placing a phone call using the first SIM. The processor may be configured to place the phone call using the first SIM in response to receiving an indication from a user to place an emergency call. The processor may be configured to perform the action using the first SIM by measuring, using the first positioning assistance data, a parameter of each signal of a plurality of positioning signals for use in determining a location of the UE, the plurality of positioning signals being received from a respective signal emitter of a plurality of signal emitters.

An example of a user equipment (UE) includes a first subscriber identifying means associated with a first network; a second subscriber identifying means associated with a second network; a communicating means for communicating with the first network using the first subscriber identifying means and the second network using the second subscriber identifying means; a determining means for determining that a quality of first positioning assistance data associated with the first subscriber identifying means is greater than a quality of second positioning assistance data associated with the second subscriber identifying means; and an action performing means for performing an action using the first subscriber identifying means in response to determining that the quality of first positioning assistance data associated with the first subscriber identifying means is greater than the quality of second positioning assistance data associated with the second subscriber identifying means.

Implementations of such a UE may also, or alternatively, include one or more of the following features. The determining means may be further for comparing a first number of positioning techniques for which information is included in the first positioning assistance data and a second number of positioning techniques for which information is included in the second positioning assistance data. The determining means may be further for comparing a first number of signal emitters for which information is included in the first positioning assistance data and a second number of signal emitters for which information is included in the second positioning assistance data.

An example of a non-transitory, processor-readable storage medium includes processor-readable instructions configured to cause a processor of a user equipment (UE) to determine that a quality of first positioning assistance data associated with a first subscriber identity module (SIM) of the UE is greater than a quality of second positioning assistance data associated with a second SIM of the UE; and perform an action using the first SIM in response to determining that the quality of first positioning assistance data associated with the first SIM is greater than the quality of second positioning assistance data associated with the second SIM.

Implementations of such a non-transitory, processor-readable storage medium may also, or alternatively, include one or more of the following features. The instructions configured to cause the processor to determine that a quality of first positioning assistance data associated with a first subscriber identity module (SIM) of the UE is greater than a quality of second positioning assistance data associated with a second SIM of the UE may include instructions configured to cause the processor to compare a first number of positioning techniques for which information is included in the first positioning assistance data and a second number of positioning techniques for which information is included in the second positioning assistance data. The instructions configured to cause the processor to determine that a quality of first positioning assistance data associated with a first subscriber identity module (SIM) of the UE is greater than a quality of second positioning assistance data associated with a second SIM of the UE may include instructions configured to cause the processor to compare the first number of signal emitters for which information is included in the first positioning assistance data and a second number of signal emitters for which information is included in the second positioning assistance data.

### BRIEF DESCRIPTION OF THE DRAWINGS

Non-limiting and non-exhaustive examples of methods and systems are described with reference to the following figures. The figures may not be drawn to scale.

FIG. 1 is a simplified diagram of an example communications environment.

FIG. 2 is a block diagram of an example UE shown in FIG. 1.

FIG. 3 is a call flow diagram associated with an example positioning technique.

FIG. 4 is an example of positioning assistance data that may be used by the UE of FIG. 2.

FIG. 5 is a flow diagram of an example method of operating the UE of FIG. 2.

### DETAILED DESCRIPTION

Items and/or techniques described herein may provide improved location accuracy and shorter times to determining an initial location solution. These improved capabilities may be achieved by intelligently selecting a subscription, from multiple subscriptions available to the multi-SIM device, for performing one or more actions based on the quality of positioning assistance data associated with the subscriptions. Other capabilities may be provided and not every implementation according to the disclosure must provide any, let alone all, of the capabilities discussed. Further, it may be possible for an effect noted above to be achieved by means other than that noted, and a noted item/technique may not necessarily yield the noted effect.

Techniques are discussed herein for performing an action using a first subscription selected from multiple available subscriptions based on a quality of positioning assistance data associated with the first subscription. Conventionally, a user of a dual-SIM UE sets a first SIM to be a default SIM for the UE to use for a first set of actions and sets a second SIM to be the default SIM for the UE to use for a second set of actions. When the UE receives an indication to perform a particular action, the UE uses the first SIM or the second SIM based on how the user set the default behavior of the device. By basing the decision of which SIM to use on the default settings of the user, the decision is not intelligent. It is a decision based on a static setting of which SIM the user prefers to use for a particular action.

There are situations where conventional UEs base a decision on the signal strength or signal quality of the wireless network associated with the different SIMs. This allows the conventional UE to utilize the wireless network that will provide the best call quality and/or data connection. However, a conventional UE does not select a SIM to use with the goal of improving the quality of a location determination of the UE. By taking actions based on the quality of positioning assistance data associated with the subscriptions to which the UE has access, the UE can use the SIM that is likely to facilitate the highest quality location determination.

Examples of actions that a UE may perform include determining the location of the UE, initiating a phone call, or requesting data using a data plan. The actions may not immediately use or determine the location of the UE, but may do so at some later time. For example, an emergency phone call, such as an enhanced 911 (e911) call in the United States, may not initially, but later, need the wireless network carrier to provide the location of a UE to emergency responders. Thus, after an e911 call is initiated, the wireless network to which the UE connects may initiate a process for determining the location of the UE. The location determination may be based on positioning assistance data sent to the UE by one or more base stations of the wireless network. Therefore, it is advantageous for the UE to place the e911 call using the SIM with the highest quality positioning assistance data.

The quality of the positioning assistance data may be determined based on a number of factors, including a number of positioning techniques for which information is included in the positioning assistance data, a number of signal emitters associated with a particular technique, or an uncertainty value associated with the positioning assistance data. Furthermore, the quality of positioning assistance data may be determined by the UE or by an external server which sends an indicator of the quality to the UE.

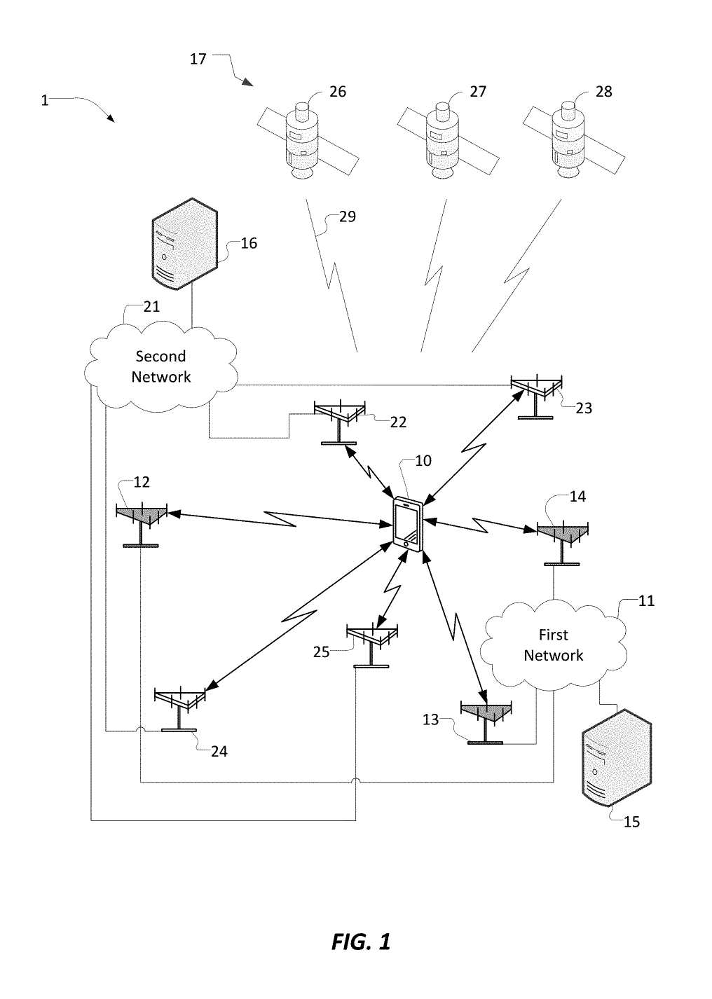

Referring to FIG. 1, a UE 10 is configured to communicate with multiple base stations in a communications environment 1, which includes a first network 11 and a second network 21. The two networks 11, 21 are cellular communications networks that allow the UE 10 to send and receive telephone calls and data. Base stations 12-14 are used by the first network 11 to wirelessly send information to and receive information from the UE 10 using a first subscription associated with a first SIM of the UE 10, and base stations 22-25 are used by the second network 21 to wirelessly send information to and receive information from the UE 10 using a second subscription associated with a second SIM of the UE 10. The base stations 12-14 are communicatively coupled to the first network 11 using, for example, a physical connection, such as a wired or optical connection. The base stations 22-25 are communicatively coupled to the second network 21 using, for example, a physical connection, such as a wired or optical connection.

The UE 10 is configured to transmit radio frequency (RF) signals to, and receive RF signals from, the base stations 12-14 using the first subscription, and transmit RF signals to, and receive RF signals from, the base stations 22-25 using the second subscription. Each of the base stations 12-14, 22-25 may be a wireless base transceiver station (BTS), a Node B, an evolved NodeB (eNB), a femtocell, a Home Base Station, a small cell base station, a Home Node B (HNB), a Home eNodeB (HeNB), etc. The first network 11 and the second network 21 may each be a 2G, a 3G, a 4G, or a 5G network, or be a hybrid network (e.g., a 3G/4G network). The first network 11 need not be the same type of network as the second network 21. The first network 11 and the second network 21 are operated by different carriers (e.g., Verizon®, AT&T®, T-Mobile®, Sprint®, etc.). The UE 10 may communicate to the two networks 11, 21 using one or more radio access technologies (RATs), such as GSM (Global System for Mobile Communications), code division multiple access (CDMA), wideband CDMA (WCDMA), Time Division CDMA (TD-CDMA), Time Division Synchronous CDMA (TDS-CDMA), CDMA2000, High Rate Packet Data (HRPD), or long term evolution (LTE). These are examples of network technologies that may be used to communicate with the UE 10 over a wireless link, and claimed subject matter is not limited in this respect. GSM, WCDMA and LTE are technologies defined by 3GPP. CDMA and HRPD are technologies defined by the 3rd Generation Partnership Project 2 (3GPP2). WCDMA is also part of the Universal Mobile Telecommunications System (UMTS) and may be supported by an HNB. Additionally, both the first network 11 and the second network 21 may support more than one RAT. For example, the first network 11 may communicate with the UE 10 using W-CDMA and LTE. Further, while three base stations are illustrated in FIG. 1 for the first network 11 and four base stations are illustrated for the second network 21, different numbers of base stations may be used.

The UE 10 receives a variety of wireless signals from base stations 12-14 and base stations 22-25. One base station per network is designated as the primary base station for communication with the UE 10. The primary base station (sometimes referred to as the serving base station or the serving cell) is the base station with which the UE 10 manages the communication with the network. For example, the base station 14 may be the primary base station for the first network 11 and the base station 25 may be the primary base station for the second network 21. The primary base station may change as the UE 10 moves throughout the communications environment 1.

The primary base station 14 sends positioning assistance data to the UE 10 for use in performing a positioning technique. The positioning assistance data includes information about the positioning signals that the UE 10 is expected to receive from the other base stations 12-13 for the first network 11. The positioning assistance data includes at least an indication of the identity of the other base stations, an indication of the channel (corresponding to an RF band) that each base station will use to send the positioning signal, and an indication of the time at which the positioning signal is expected to be received. The indication of the time at which the positioning signal is expected to be received may include an indication of the location of the positioning signal within a frame received from a base station. The indication of the location of the positioning signal within a frame may be an indication of a periodicity of the positioning signal (measured in milliseconds or number of sub-frames), an indication of a sub-frame offset value of the positioning signal, and an indication of the duration of the positioning signal (measured in milliseconds or number of sub-frames). In the case of OTDOA, the positioning signals are positioning reference signals (PRS), as defined by the LTE standard. The assistance data for OTDOA is sent from a location server 15 for the first network 11 or a location server 16 for the second network 21. Information about the location of the base stations that are expected to send the PRS signals may not be included in the OTDOA assistance data because the determination of the location of the UE 10 using OTDOA may occur on the network side (e.g., on the server 15 or the server 16), not on the UE 10. When performing OTDOA, the UE 10 makes time difference measurements that are used by the location server 15 to determine the location.

The location server 15 and the location server 16 may each be one of a variety of server types. For example, the location servers 15 and 16 may each be an Evolved Serving Mobile Location Centre (E-SMLC), a Secure User Plane Location (SUPL) Location Platform (SLP), a SUPL Location Center (SLC), a SUPL Positioning Center (SPC), a Position Determining Entity (PDE) and/or a gateway mobile location center (GMLC), each of which may connect to one or more location retrieval functions (LRFs) and/or mobility management entities (MMEs).

The UE 10 can also use a satellite positioning system (SPS) 17 to determine the location of the UE 10. The SPS 17 includes multiple satellites (for clarity only three satellites 26-28 are illustrated in FIG. 1, but more than three satellites may be used) that emit RF positioning signals, such as RF positioning signal 29 emitted by the satellite 26. The SPS 17 may be a Global Positioning System (GPS), Global Navigation Satellite System (GNSS), Galileo, GLONASS, Beidou (Compass), etc. The satellites 26-28 are referred to as satellites, but may be other space vehicles that are not in orbit around the Earth that emit reference signals. The UE 10 may have circuitry and processing resources capable of making location-related measurements (e.g., based on the RF positioning signal 29 received from the SPS satellite 26) and computing a position fix or estimated location of the UE 10 based on these location-related measurements. The assistance data received from the location server 15 and the assistance data received from the location server 16 by the UE 10 may include information that assists the UE 10 in making the location-related measurements. The information about the SPS received from the two location servers, associated with different SIMs of the UE 10, may be different information. For example, the assistance data from the location server 15 may include information associated with a greater number of satellites than the assistance data from the location server 16.

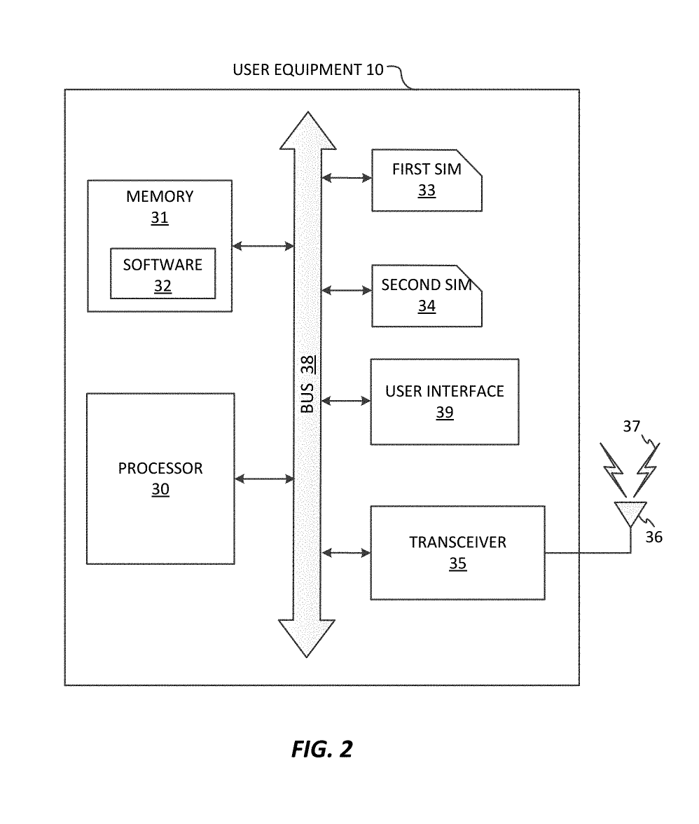

Referring to FIG. 2, with further reference to FIG. 1, an example of the UE 10 includes a processor 30, a memory 31, software 32, a first SIM 33, a second SIM 34, a user interface 39 and a transceiver 35. The UE 10 is a computer system that may be a handheld mobile device, such as a mobile phone or smart phone. The processor 30 is an intelligent device, e.g., a central processing unit (CPU) such as those made or designed by Qualcomm®, ARM®, Intel® Corporation, or AMD®, a microcontroller, an application specific integrated circuit (ASIC), etc. The processor 30 may, for example, include an image signal processor (ISP). The memory 31 is a non-transitory, processor-readable memory that stores instructions that may be executed by processor 30 and includes random access memory (RAM), read-only memory (ROM) and non-volatile memory such as flash memory or solid state storage. The software 32 can be loaded onto the memory 31 by being downloaded via a network connection, uploaded from a disk, etc. Further, the software 32 may not be directly executable, e.g., requiring compiling before execution. The software 32 includes instructions configured to cause the processor 30 to perform functions described herein.

The first SIM 33 and the second SIM 34 are separate and distinct SIMs that are configured to provide access to a first subscription associated with the first network 11 and a second subscription associated with the second network 21, respectively. The SIMs may be, for example, a Universal Integrated Circuit Card (UICC) and may include a processor, ROM, RAM, Electrically Erasable Programmable Read-Only Memory (EEPROM) and/or circuitry. The first SIM 33 is configured to store user account information, an international mobile subscriber identity (IMSI), SIM application toolkit (SAT) command instructions, and storage space for additional information, such as telephone book contact information.

The user interface 39 is configured to accept input from a user of the UE 10 and provide output to the user of the UE 10. The user interface 39 may include a keyboard, a keypad, a touchscreen, a display, and one or more buttons. The user interface 39 is configured to receive indications from the user of the UE 10. For example, the user interface 39 is configured to receive an indication from the user to place a phone call. This may be achieved by the user pressing buttons, keys or the touchscreen to dial number or select a contact. For example, the user may dial 911 to indicate that an emergency phone call should be initiated. Alternatively, the user may select an application that requires the location of the UE 10 to indicate that a location determination for the UE 10 should be performed.

The various components of the UE 10 are communicatively coupled to one another via a bus 38, which is configured to transmit information from one component to another component. For example, the processor 30 is communicatively coupled to the first SIM 33, the second SIM 34, the transceiver 35, the user interface 39 and the memory 31 via the bus 38. The processor 30 is configured to send commands to the first SIM 33 and the second SIM 34 via the bus 38 and the SIMs 33, 34 are configured to send information, such as the IMSI to the processor 30. The processor 30 is further configured to send information to the transceiver 35, such as a message that includes the IMSI of one of the SIMs 33, 34, via the bus 38 for wireless transmission by the transceiver 35. The transceiver 35 is configured to send messages wirelessly received from a base station of a wireless network to the processor 30.

The transceiver 35 is configured to receive wireless signals 37, sent by one or more base stations, via an antenna 36. The transceiver 35 may be a single device that performs transmit and receive functions for both SIMs 33, 34, or the transceiver 35 may include two separate transceivers—a first transceiver configured to transmit and receive signals for the first SIM 33 and a second transceiver configured to transmit and receive signals for the second SIM 34. By way of example and not limitation, the transceiver 35 may be configured to receive first assistance data associated with the first SIM 33 and second assistance data associated with the second SIM 34. Alternatively or additionally, the transceiver 35 may be configured to receive a first indication of the quality of the first assistance data and a second indication of the quality of the second assistance data.

The assistance data associated with each of the SIMs 33, 34 includes information that may be used by the UE 10 for performing one or more positioning techniques. One such positioning technique is OTDOA positioning, which uses the LTE positioning protocol (LPP) for sending information between the UE 10 and the location server 15. However, the LPP protocol, or similar protocols, may be used for other positioning techniques, including satellite based positioning. The term LPP as used herein includes LPP Extensions (LPPe).

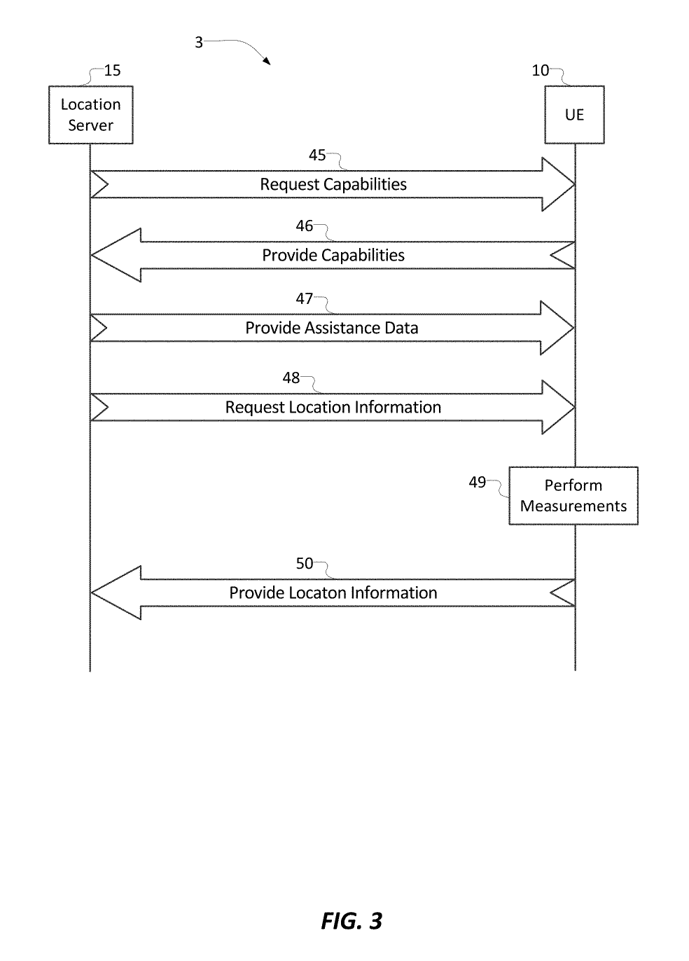

Referring to FIG. 3, with further reference to FIGS. 1-2, the UE 10 and the location server 15 exchange several messages when using the LPP protocol to perform OTDOA positioning. While FIG. 3 and the following description describe the flow of messages sent between the UE 10 and the location server 15, the UE 10 and the location server 15 are configured to perform the respective functions discussed.

The location server 15 sends a request capabilities message 45 to the UE 10, which includes information that indicates the type of capabilities requested. The request capabilities message 45 may, for example, indicate that the location server 15 is requesting a particular positioning technique, such as OTDOA or a satellite positioning technique.

The UE 10 responds to the request capabilities message 45 by sending, to the location server 15, a provide capabilities message 46, which includes information about the capabilities of the UE 10. For example, if OTDOA capabilities were requested by the request capabilities message 45, the provide capabilities message 46 includes information regarding the type of OTDOA mode that the UE 10 supports (e.g., UE-assisted or UE-based OTDOA), the frequency bands (i.e., channels) for which the UE 10 supports Reference Signal Time Difference (RSTD) measurements, and whether the UE 10 supports inter-frequency RSTD measurements.

The location server 15 sends a provide assistance data message 47 to the UE 10. The provide assistance data message 47 includes positioning assistance data information that is used by the UE 10 to perform measurements on incoming positioning signals. The assistance data information may include information about signals that will be sent from the serving base station, neighboring base stations or other signal emitters. For example, for OTDOA the assistance data information may include a cell identifier that identifies the base station to which the information relates, positioning signal timing information (e.g., timing offset, periodicity, and duration of the positioning signals sent by the associated base station), an expected RSTD value the UE 10 is expected to measure, and an uncertainty of the expected RSTD value.

The location server 15 may send, e.g., at any time, a request location information message 48 to the UE 10, which is a request for RSTD measurements from the UE 10. The request location information message 48 may include an indication of the type of location information that is desired (e.g., RSTD measurements), the desired accuracy of the location estimate, and/or a response time at which the UE 10 should send the location information to the location server 15.

In response to the request location information message 48, the UE 10 performs the RSTD measurements, as indicated by stage 49. The measurements are performed using the assistance data. For example, the processor 30 is configured to tune the transceiver 35 to particular channels at respective times in order to receive positioning signals based on the positioning timing information received as part of the assistance data. Measurement results may include, for each received positioning signal, a time stamp of when the signal was received, an identity of the reference cell from which the signal was received, and an indication of the quality of the measurement. The processor 30 causes the measurement results to be stored in the memory 31 until the response time at which the UE 10 sends the measurements results to the location server 15.

When the response time received as part of the request location information message 48 expires, the measurement results are sent by the UE 10 to the location server 15 in a provide location information message 50. The location server 15 can use the measurement results to determine the location of the UE 10.

The call flow diagram of FIG. 3 is only an example of a positioning technique based on LPP. The messages illustrated in FIG. 3 may be one of multiple messages used to send particular information, e.g., if the information is too large to fit into a single message. Additionally, the assistance data included in the provide assistance data message 47 may include assistance data for more than one positioning technique. Alternatively or additionally, assistance data may be received from more than one source. For example, in addition to receiving assistance data from the location server 15, assistance data may be received from a third party server that is not associated with the network 11 or the network 21, or with any one particular network.

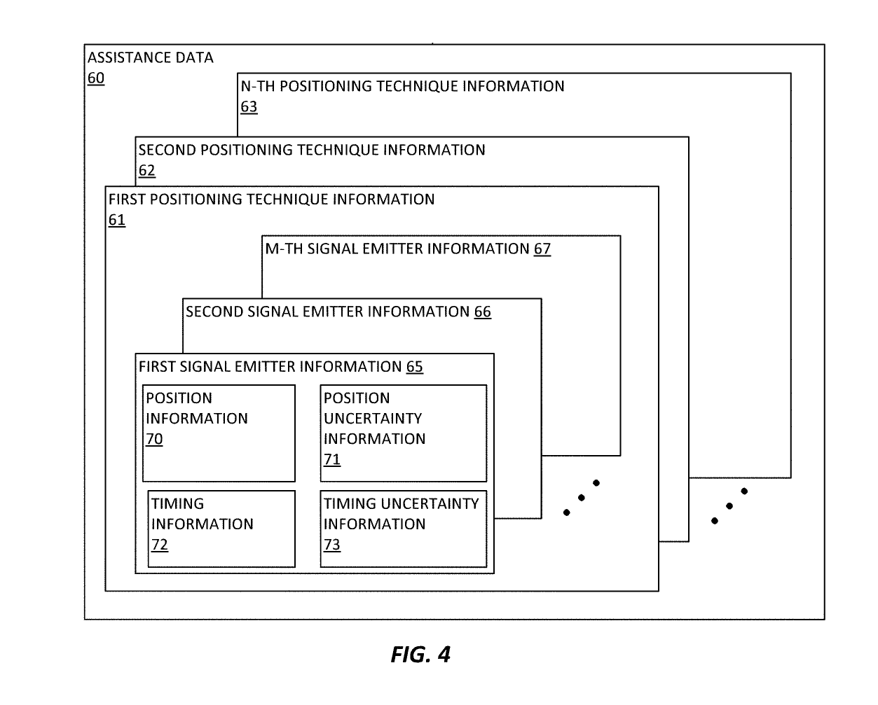

Referring to FIG. 4, in one implementation, the assistance data 60 includes information for use by the UE 10 for performing one or more positioning techniques. As discussed above, the UE 10 may receive first assistance data associated with the first SIM 33 and second assistance data associated with the second SIM 34. The assistance data 60 is illustrative of the first assistance data and the second assistance data. The assistance data 60 includes first positioning technique information 61, second positioning technique information 62, and N-th positioning technique information 63, but less positioning technique information may be used or other positioning technique information may also be included. For the sake of simplicity and clarity, FIG. 4 only illustrates details for the first position technique information 61. The information associated with a particular positioning technique may be the same as or different from the information associated with other positioning techniques. The positioning techniques for which information is included in the assistance data 60 can include, but are not limited to, SPS positioning, OTDOA positioning, Wi-Fi-based positioning, Bluetooth-based positioning, enhanced cell identification (E-CID) positioning, or barometric-pressure based positioning.

The first positioning technique information 61 includes a first signal emitter information 65, a second signal emitter information 66, and an M-th signal emitter information 67, but less signal emitter information may be provided or information for additional signal emitters may also be included. The signal emitters are the source of positioning signals used by the UE 10 to perform positioning techniques. Examples of signal emitters include satellites, base stations, Wi-Fi access points, Bluetooth devices, or other devices that emit a signal that may be used for determining the position of the UE 10. For the sake of simplicity and clarity, FIG. 4 only illustrates details for the first signal emitter information 65. The information associated with a particular signal emitter may be the same as or different from the information associated with other positioning techniques. Additionally, the type of emitter and the signal emitter information may be different for the information associated with different positioning techniques.

The first signal emitter information 65 includes position information 70, position uncertainty information 71, timing information 72, and timing uncertainty information 73. The position information 70 includes an indication of the location of the first signal emitter. The UE 10 or the location server 15 can use the position information in connection with RSTD measurements, or another measurement based on the time of arrival or time difference of arrival of signals from the first signal emitter and other signal emitters, to approximate the location of the UE 10. For example, the position information 70 may include a latitude, longitude and elevation value for the first signal emitter. Alternatively or additionally, the position information 70 may include ephemeris data for the first signal emitter, which could be a satellite. Ephemeris data may include information about the orbit of the satellite, such as an indication of the orbital plane, an indication of the eccentricity of the orbital ellipse, an indication of the length of the semi-major axis, an indication of the location of the satellites perigee, an indication of the satellite's position on the orbital ellipse at a reference time, an indication of the satellite's speed at the reference time, and other information detailing the orbit of the satellite. The position uncertainty information 71 includes an indication of how certain the location server 15 is regarding the accuracy of the position information 70. For example, the position uncertainty information 71 may include an estimated error in the position of the first signal emitter, a standard deviation of the position of the first signal emitter or another indication of error in the position of the first signal emitter. The timing information 72 includes an estimate of when the UE 10 should receive a positioning signal. For example, the timing information 72 may include a periodicity, a timing offset and a duration of a positioning signal emitted by the first signal emitter. Alternatively or additionally, the timing information 72 may include an indication of the time that a particular positioning signal is expected to arrive at the UE 10. The timing uncertainty information 73 includes an indication of the uncertainty in the timing information 72. For example, the timing uncertainty information 73 may be a time duration or a number of sub-frames around the expected time of arrival of the positioning signal at the UE 10.

The second signal emitter information 66 and the M-th signal emitter information 67 may include similar information as described in connection with the first signal emitter information 65, but in connection with the second signal emitter and the M-th signal emitter, respectively. Furthermore, the second positioning technique information 62 and the N-th positioning technique information 63 may include similar information as described in connection with the first positioning technique information 61, but in connection with the second positioning technique and the N-th positioning technique, respectively.

Referring back to FIG. 2, with further reference to FIG. 1 and FIGS. 3-4, the processor 30 is configured to determine that a quality of first positioning assistance data associated with the first SIM 33 is greater than a quality of second positioning assistance data associated with the second SIM 34. For example, the processor 30 may be configured to determine a first indication of the quality of the first positioning assistance data and a second indication of the quality of the second positioning assistance data and compare the first indication to the second indication.

Alternatively, the transceiver 35 may be configured to receive indications of the quality of the first positioning assistance data and/or the quality of the second positioning assistance data from a third party server. For example, the third party server may receive indications of quality information from multiple other UEs that are in a similar geographic location as the UE 10 and use the crowdsourced information to determine an aggregated indication of the quality of the assistance data. The aggregated indication of the quality of the assistance data is sent to the UE 10, where it is received by the transceiver 35 via the antenna 36. By way of example and not limitation, the aggregated indication of quality can be an average or a median of the crowdsourced indications received from multiple other UEs.

Whether the quality is determined by the UE 10 or by another device, such as a third party server, the quality may be based on a number of parameters included in the assistance data 60. For example, the processor 30 may be configured to determine the quality of the assistance data 60 based on the number of positioning techniques for which information is included in the assistance data. The assistance data 60 includes information for N different positioning techniques. The quality of the assistance data 60 typically increases as the value of N increases. Thus, the processor 30 may be configured to determine that a quality of first assistance data associated with the first SIM 33 is greater than a quality of second assistance data associated with the second SIM 34 by determining that the first assistance data contains information for a larger number of positioning techniques than the second assistance data. By way of example and not limitation, the first assistance data may include information associated with GNSS positioning and OTDOA positioning and the second assistance data may only include information for GNSS positioning only. It is likely that the first SIM 33, associated with two different positioning techniques in this example, will provide better location determination capabilities than the second SIM 34. Accordingly, in this example, when performing an action that may use the location of the UE 10 as determined by one or more of the available techniques, the processor 30 performs the action using the first SIM 33 because the first SIM 33 is likely to provide a faster and/or more accurate location determination than the second SIM 34.

Additionally or alternatively, the processor 30 may be configured to determine the quality of the assistance data 60 based on the number of signal emitters for which information is included in the assistance data. The assistance data 60 includes information for M different signal emitters as part of the first positioning technique information. The quality of the assistance data 60 typically increases as the value of M increases. Thus, the processor 30 may be configured to determine that a quality of first assistance data associated with the first SIM 33 is greater than a quality of second assistance data associated with the second SIM 34 by determining that the first assistance data contains information for a larger number of signal emitters than the second assistance data. By way of example and not limitation, the first assistance data and the second assistance data may both include information associated with OTDOA positioning. However, the first assistance data may include information for a number of emitters that is greater than the number of emitters for which the second assistance data includes information. It is likely that the first SIM 33, associated with a greater number of emitters in this example, will provide better location determination capabilities than the second SIM 34. Accordingly, in this example, when performing an action that may use the location of the UE 10 as determined by one or more of the available techniques, the processor 30 performs the action using the first SIM 33 because the first SIM 33 is likely to provide a faster and/or more accurate location determination than the second SIM 34. This example is a situation where there only is information for a single positioning technique in both the first assistance data and the second assistance data. When there is more than one positioning technique, however, the quality of the assistance data may be based on the sum total of all signal emitters for all available positioning techniques. Alternatively, the quality of the assistance data may be based on a weighted sum of all signal emitters for all available positioning techniques where each positioning technique is associated with a respective weight. For example, the number of OTDOA signal emitters may be given a greater weight than the number of GNSS signal emitters because OTDOA is likely to provide more reliable location determination than GNSS in certain situations, such as when the UE is located in an indoor environment. Thus, in the case where the first assistance data includes information for six GNSS signal emitters and eight OTDOA signal emitters and the second assistance data includes information for ten GNSS signal emitters and five OTDOA signal emitters, it may be that the processor 30 determines that the first assistance data has a higher quality than the second assistance data, even though the second assistance data has a greater number of total signal emitters than the first assistance data (15 signal emitters versus 14 signal emitters).

Additionally or alternatively, the processor 30 may be configured to determine the quality of the assistance data 60 based on an uncertainty value included in the first assistance data. The assistance data 60 includes first signal emitter information 65, which includes position uncertainty information 71 and timing uncertainty information 73. The quality of the assistance data 60 typically increases as these uncertainty values decreases. Thus, the processor 30 may be configured to determine that a quality of first assistance data associated with the first SIM 33 is greater than a quality of second assistance data associated with the second SIM 34 by determining that the first assistance data includes an uncertainty that is less than an uncertainty included in the second assistance data. The uncertainty that is compared may be an aggregation (e.g., an average, a median, a weighted average, etc.) of the uncertainty for the multiple signal emitters for which information is provided by the assistance data. By way of example and not limitation, the first assistance data and the second assistance data may both include information associated with GNSS positioning and the GNSS positioning information may include information for the same number of signal emitters. However, the first assistance data may have an average uncertainty in the position of the emitters associated with the first SIM 33 that is less than an average uncertainty in the position of the emitters associated with the second SIM 34. It is likely that the first SIM 33, associated with a smaller uncertainty in this example, will provide better location determination capabilities than the second SIM 34. Accordingly, in this example, when performing an action that may use the location of the UE 10 as determined by one or more of the available techniques, the processor 30 performs the action using the first SIM 33 because the first SIM 33 is likely to provide a faster and/or more accurate location determination than the second SIM 34.

While the above examples have described various techniques for determining the quality of assistance data separately, the quality of the assistance data may be based on more than one type of the various information included in the assistance data. For example, a quality may be a function of the number of positioning techniques for which information is provided, the number of signal emitters for which information is provided, and an uncertainty associated with the assistance data. The function may be a weighted sum of the various information from the assistance data, where each type of information is associated with a weight. Alternatively, quality functions more complicated than a weighted sum may be constructed to determine the quality of the assistance data.

The processor 30 is configured to, in response to a determination that the quality of the first assistance data is greater than the quality of the second assistance data, perform an action using the first SIM 33. The action may, at least initially, not involve determining a location of the UE 10. Examples of actions that the processor 30 may perform include determining the location of the UE 10, initiating a phone call, or requesting data using a data plan. The actions may include using or determining the location of the UE 10 immediately or at some future time. For example, an emergency phone call, such as an enhanced 911 (e911) call in the United States, may have the wireless network carrier provide the location of a UE 10 to emergency responders. Thus, after an e911 call is initiated, the wireless network to which the UE 10 connects may initiate a process for determining the location of the UE 10. The location determination may be based on assistance data sent to the UE 10 by one or more base stations of the wireless network. Therefore, it may be advantageous for the UE 10 to place the e911 call using the SIM with the highest quality assistance data (i.e., higher quality assistance data if only two SIMs are available). Similarly, any telephone call that may result in implementing a positioning technique may benefit from using the SIM with the highest quality assistance data. For example, emergency calls in other countries may similarly be placed using the SIM with the highest quality assistance data. In response to a user dialing an emergency number, the UE 10 may initiate the call to the emergency number using the SIM associated with the higher quality assistance data. Examples of emergency numbers include, but are not limited to, 911 In the United States, 999 in the United Kingdom, 112 in certain European countries, 000 in Australia, and 119 and 110 in Japan.

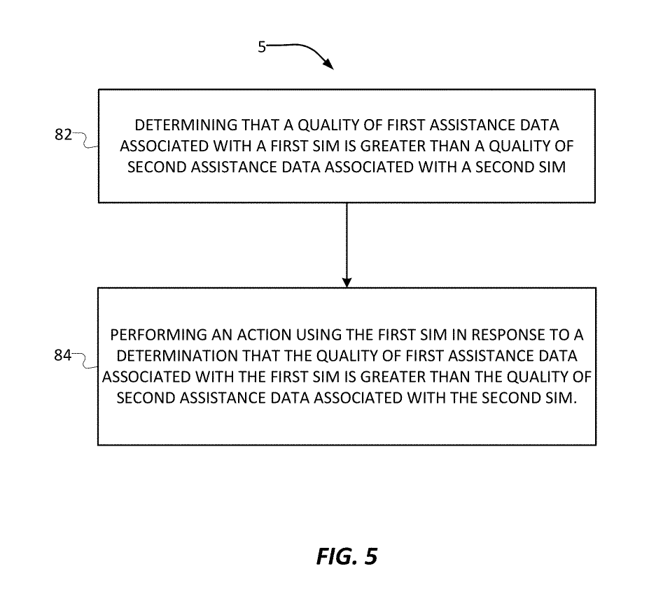

Referring to FIG. 5, with further reference to FIGS. 1-4, a method 5 of operating a UE 10 that includes a first SIM and a second SIM includes the stages shown. The method 5 is, however, an example only and not limiting. The method 5 can be altered, e.g., by having stages added, removed, rearranged, combined, performed concurrently, and/or having single stages split into multiple stages.

At stage 82, the method 5 includes determining that a quality of first positioning assistance data associated with the first SIM is greater than a quality of second positioning assistance data associated with the second SIM. The processor 30 compares the quality of the first assistance data and the quality of the second assistance data to determine which is greater. The processor 30 may first determine the quality of the first assistance data and the quality of the second assistance data. This may be achieved by receiving the first assistance data and the quality second assistance data from transceiver 35, which receives signals containing the assistance data via antenna 36. As described above, the processor 30 may determine the quality of assistance data based on a number positioning techniques for which information is included in the assistance data, a number of signal emitters for which information is included in the assistance data, and/or an uncertainty value included in the assistance data.

Alternatively, the quality of the first assistance data and the quality of the second assistance data may be received by transceiver 35 via antenna 36. In this situation, the quality of assistance data may be determined in the same way described above, but instead of being determined by the processor 30, an indicator of the quality is determined by at least one other device, stored on a third party server and wirelessly sent to the UE 10. The UE 10 wirelessly receives the indicator of the quality using transceiver 35 and antenna 36. The indicator of the quality is transferred to the processor 30 and/or the memory 31 via bus 38. The indicator of quality may be determined by the third party server if the third party has access to the assistance data. Alternatively, the indicator of quality may be determined by other UEs and sent to the third party server for storage. The third party server can aggregate the received indicators of quality to determine an aggregated indicator of quality. For example, the third party server may determine a median or a mean of the indicators of quality received from various UEs. The aggregated indicator of quality may be sent to the UE 10 for use in determining whether first assistance data has a higher quality than second assistance data.

Whether the quality of the assistance data is determined by the UE 10 or by another device, such as a third party server, the quality may be determined based on a number of parameters included in the assistance data 60. For example, the processor 30 may determine the quality of the assistance data 60 based on the number of positioning techniques for which information is included in the assistance data. For example, the processor 30 may determine that a quality of first assistance data associated with a first SIM is greater than a quality of second assistance data associated with a second SIM by determining that the first assistance data contains information for a larger number of positioning techniques than the second assistance data associated with a second SIM.

Additionally or alternatively, the processor 30 may determine the quality of the assistance data 60 based on the number of signal emitters for which information is included in the assistance data. For example, the processor 30 may determine that a quality of first assistance data associated with a first SIM is greater than a quality of second assistance data associated with a second SIM by determining that the first assistance data contains information for a larger number of signal emitters than the second assistance data associated with a second SIM. If there is information associated with more than one positioning technique in the assistance data, the quality of the assistance data may be based on the sum total of multiple, e.g., all, signal emitters for multiple, e.g., all, available positioning techniques or a weighted sum of multiple, e.g., all, signal emitters for multiple, e.g., all, available positioning techniques, where each positioning technique is associated with a respective weight.

Additionally or alternatively, the processor 30 may determine the quality of the assistance data 60 based on an uncertainty value included in the first assistance data. The assistance data 60 includes first signal emitter information 65, which includes position uncertainty information 71 and timing uncertainty information 73. The processor 30 may determine that a quality of first assistance data associated with a first SIM is greater than a quality of second assistance data associated with a second SIM by determining that the first assistance data includes an uncertainty that is less than an uncertainty included in the second assistance data. The uncertainty that is compared may be an aggregation (e.g., an average, a median, a weighted average, etc.) of the uncertainty for the multiple signal emitters for which information is provided by the assistance data.

In addition to the above example techniques for determining the quality of assistance data separately, the quality of the assistance data may be based on more than one of the various information included in the assistance data. For example, a quality may be determined as a function of the number of positioning techniques for which information is provided, the number of signal emitters for which information is provided, and an uncertainty associated with the assistance data. The function may be a weighted sum of the various information from the assistance data, where each type of information is associated with a weight. Alternatively, quality functions more complicated than a weighted sum may be used to determine the quality of the assistance data.

At stage 84, the method 5 includes performing an action using the first SIM in response to determining that the quality of first positioning assistance data associated with the first SIM is greater than the quality of second positioning assistance data associated with the second SIM. The processor 30 responds to a determination that the quality of the first assistance data is greater than the quality of the second assistance data, by performing an action using the first SIM. Examples of actions that the processor 30 may perform include non-location-determining actions, and/or actions determining the location of the UE 10, initiating a phone call, or requesting data using a data plan. The actions may use the location of the UE 10 immediately or at some future time. For example, an emergency phone call, such as an enhanced 911 (e911) call in the United States, may need the wireless network carrier to provide the location of a UE 10 to emergency responders. Thus, after an e911 call is initiated, the wireless network to which the UE 10 connects may initiate a process for determining the location of the UE 10. The location determination may be based on assistance data sent to the UE 10 by one or more base stations of the wireless network. Therefore, it may be advantageous for the UE 10 to place the e911 call using the SIM with the highest quality assistance data. Similarly, any telephone call that may result in implementing a positioning technique may benefit from using the SIM with the highest quality assistance data. For example, emergency calls in other countries may similarly be placed using the SIM with the highest quality assistance data. In response to a user dialing an emergency number, the UE 10 may initiate the call to the emergency number using the SIM associated with the higher quality assistance data.

The first assistance data and/or the second assistance data need not be received by the transceiver 35 at any particular time. For example, the first assistance data and/or the second assistance data may be received in response to an indication from the user of the UE 10 received by the user interface 39. Alternatively, the first assistance data and/or the second assistance data may have been received at some previous time as part of conventional communications between the UE 10 and the first network 11 and/or the second network 21. Alternatively, the first assistance data and/or the second assistance data may be historical first assistance data and/or the second assistance data that was received at some time in the past by the UE 10. The quality of assistance data that has yet to be received may be assumed to be similar to historical assistance data from when the UE 10 was in a similar location.

As mentioned above, the UE 10 may determine a quality of the first assistance data and/or a quality of the second assistance data. An indication of the quality of the assistance data may be sent to a third party server along with an indication of the current location of the UE 10. The third party server can receive indications of the quality of assistance data at various locations from multiple UEs. In this way, the quality of assistance data associated with different networks can be crowdsourced. After receiving indicators of the quality of assistance data from multiple UEs, the third party server can send an aggregation of the indicators of quality to the UE 10 for use in determining whether the quality of the first assistance data is greater than the quality of the second assistance data.

### Other Considerations

Other examples and implementations are within the scope and spirit of the disclosure and appended claims. For example, due to the nature of software and computers, functions described above can be implemented using software executed by a processor, hardware, firmware, hardwiring, or a combination of any of these. Features implementing functions may also be physically located at various positions, including being distributed such that portions of functions are implemented at different physical locations.

As used herein, “or” as used in a list of items prefaced by “at least one of” or prefaced by “one or more of” indicates a disjunctive list such that, for example, a list of “at least one of A, B, or C,” or a list of “one or more of A, B, or C” means A or B or C or AB or AC or BC or ABC (i.e., A and B and C), or combinations with more than one feature (e.g., AA, AAB, ABBC, etc.).

As used herein, unless otherwise stated, a statement that a function or operation is “based on” an item or condition means that the function or operation is based on the stated item or condition and may be based on one or more items and/or conditions in addition to the stated item or condition.

Further, an indication that information is sent or transmitted, or a statement of sending or transmitting information, “to” an entity does not require completion of the communication. Such indications or statements include situations where the information is conveyed from a sending entity but does not reach an intended recipient of the information. The intended recipient, even if not actually receiving the information, may still be referred to as a receiving entity, e.g., a receiving execution environment. Further, an entity that is configured to send or transmit information “to” an intended recipient is not required to be configured to complete the delivery of the information to the intended recipient. For example, the entity may provide the information, with an indication of the intended recipient, to another entity that is capable of forwarding the information along with an indication of the intended recipient.

Other examples and implementations are within the scope and spirit of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations.

Further, more than one invention may be disclosed.

A wireless network is a communication system in which communications are conveyed wirelessly, i.e., by electromagnetic and/or acoustic waves propagating through atmospheric space rather than through a wire or other physical connection. A wireless network may not have all communications transmitted wirelessly, but is configured to have at least some communications transmitted wirelessly.

Substantial variations to described configurations may be made in accordance with specific requirements. For example, customized hardware might also be used, and/or particular elements might be implemented in hardware, software (including portable software, such as applets, etc.), or both. Further, connection to other computing devices such as network input/output devices may be employed.

Common forms of physical and/or tangible computer-readable media include, for example, a floppy disk, a flexible disk, hard disk, magnetic tape, or any other magnetic medium, a CD-ROM, any other optical medium, punch cards, paper tape, any other physical medium with patterns of holes, a RAM, a PROM, EPROM, a FLASH-EPROM, any other memory chip or cartridge, a carrier wave as described hereinafter, or any other medium from which a computer can read instructions.

The processes, systems, and devices discussed above are examples. Various configurations may omit, substitute, or add various procedures or components as appropriate. For instance, in alternative configurations, the processes may be performed in an order different from that described, and that various steps may be added, omitted, or combined. Also, features described with respect to certain configurations may be combined in various other configurations. Different aspects and elements of the configurations may be combined in a similar manner. Also, technology evolves and, thus, many of the elements are examples and do not limit the scope of the disclosure or claims.

Specific details are given in the description to provide a thorough understanding of example configurations (including implementations). However, configurations may be practiced without these specific details. For example, well-known circuits, processes, algorithms, structures, and techniques have been shown without unnecessary detail in order to avoid obscuring the configurations. This description provides example configurations only, and does not limit the scope, applicability, or configurations of the claims. Rather, the preceding description of the configurations provides a description for implementing described techniques. Various changes may be made in the function and arrangement of elements without departing from the spirit or scope of the disclosure.

Also, configurations may be described as a process which is depicted as a flow diagram or block diagram. Although each may describe the operations as a sequential process, some operations may be performed in parallel or concurrently. In addition, the order of the operations may be rearranged. A process may have additional stages or functions not included in the figure. Furthermore, examples of the methods may be implemented by hardware, software, firmware, middleware, microcode, hardware description languages, or any combination thereof. When implemented in software, firmware, middleware, or microcode, the program code or code segments to perform the tasks may be stored in a non-transitory computer-readable medium such as a storage medium. Processors may perform one or more of the described tasks.

Components, functional or otherwise, shown in the figures and/or discussed herein as being connected or communicating with each other are communicatively coupled. That is, they may be directly or indirectly connected to enable communication between them.

Having described several example configurations, various modifications, alternative constructions, and equivalents may be used without departing from the spirit of the disclosure. For example, the above elements may be components of a larger system, wherein other rules may take precedence over or otherwise modify the application of the invention. Also, a number of operations may be undertaken before, during, or after the above elements are considered. Accordingly, the above description does not bound the scope of the claims.

A statement that a value exceeds (or is more than or above) a first threshold value is equivalent to a statement that the value meets or exceeds a second threshold value that is slightly greater than the first threshold value, e.g., the second threshold value being one value higher than the first threshold value in the resolution of a computing system. A statement that a value is less than (or is within or below) a first threshold value is equivalent to a statement that the value is less than or equal to a second threshold value that is slightly lower than the first threshold value, e.g., the second threshold value being one value lower than the first threshold value in the resolution of a computing system.

What is claimed is:

1. A method for operating a user equipment (UE) comprising a first subscriber identity module (SIM) and a second SIM, the method comprising:
determining that a quality of first positioning assistance data associated with the first SIM is greater than a quality of second positioning assistance data associated with the second SIM; and
performing an action using the first SIM in response to determining that the quality of the first positioning assistance data associated with the first SIM is greater than the quality of the second positioning assistance data associated with the second SIM.

2. The method of claim 1, wherein the determining that a quality of first positioning assistance data associated with the first SIM is greater than a quality of second positioning assistance data associated with the second SIM comprises comparing a first number of positioning techniques for which information is included in the first positioning assistance data and a second number of positioning techniques for which information is included in the second positioning assistance data.

3. The method of claim 2, wherein the determining that the quality of the first positioning assistance data associated with the first SIM is greater than the quality of the second positioning assistance data associated with the second SIM comprises determining that the first number of positioning techniques is greater than the second number of positioning techniques.

4. The method of claim 1, wherein the determining that a quality of first positioning assistance data associated with the first SIM is greater than a quality of second positioning assistance data associated with the second SIM comprises comparing a first number of signal emitters for which information is included in the first positioning assistance data and a second number of signal emitters for which information is included in the second positioning assistance data.

5. The method of claim 4, wherein the determining that the quality of the first positioning assistance data associated with the first SIM is greater than the quality of the second positioning assistance data associated with the second SIM comprises determining that the first number of signal emitters is greater than the second number of signal emitters.

6. The method of claim 1, wherein the determining that a quality of first positioning assistance data associated with the first SIM is greater than a quality of second positioning assistance data associated with the second SIM comprises comparing a first uncertainty value included in the first positioning assistance data and a second uncertainty value included in the second positioning assistance data.

7. The method of claim 6, wherein the first uncertainty value and the second uncertainty value each comprise at least one of a location uncertainty of a location of a respective signal emitter or a timing uncertainty of a time of arrival of a respective signal.

8. The method of claim 1, further comprising:
determining, with a processor of the UE, a first indication of the quality of the first positioning assistance data; and
determining, with the processor of the UE, a second indication of the quality of the second positioning assistance data.

9. The method of claim 1, further comprising:
receiving, from a server, a first indication of the quality of the first positioning assistance data and a second indication of the quality of the second positioning assistance data.

10. The method of claim 1, wherein the performing the action using the first SIM comprises placing a phone call using the first SIM.

11. The method of claim 10, wherein the placing the phone call using the first SIM is done in response to receiving an indication from a user to place an emergency call.

12. The method of claim 1, wherein the performing the action using the first SIM comprises measuring, using the first positioning assistance data, a parameter of each signal of a plurality of positioning signals for use in determining a location of the UE, the plurality of positioning signals being received from a respective signal emitter of a plurality of signal emitters.

13. A user equipment (UE) comprising:
a first subscriber identity module (SIM) associated with a first network;
a second SIM associated with a second network;
a transceiver configured to communicate with the first network using the first SIM and the second network using the second SIM;
a processor, communicatively coupled to the transceiver, the first SIM and the second SIM, configured to:
determine that a quality of first positioning assistance data associated with the first SIM is greater than a quality of second positioning assistance data associated with the second SIM; and
perform an action using the first SIM in response to determining that the quality of first positioning assistance data associated with the first SIM is greater than the quality of second positioning assistance data associated with the second SIM.

14. The UE of claim 13, wherein the processor is configured to determine that the quality of the first positioning assistance data associated with the first SIM is greater than the quality of the second positioning assistance data associated with the second SIM by comparing a first number of positioning techniques for which information is included in the first positioning assistance data and a second number of positioning techniques for which information is included in the second positioning assistance data.

15. The UE of claim 14, wherein the processor is configured to determine that the quality of the first positioning assistance data associated with the first SIM is greater than the quality of the second positioning assistance data associated with the second SIM by determining that the first number of positioning techniques is greater than the second number of positioning techniques.

16. The UE of claim 13, wherein the processor is configured to determine that the quality of the first positioning assistance data associated with the first SIM is greater than the quality of the second positioning assistance data associated with the second SIM by comparing a first number of signal emitters for which information is included in the first positioning assistance data and a second number of signal emitters for which information is included in the second positioning assistance data.

17. The UE of claim 16, wherein the processor is configured to determine that the quality of the first positioning assistance data associated with the first SIM is greater than the quality of the second positioning assistance data associated with the second SIM by determining that the first number of signal emitters is greater than the second number of signal emitters.

18. The UE of claim 13, wherein the processor is configured to determine that the quality of the first positioning assistance data associated with the first SIM is greater than the quality of the second positioning assistance data associated with the second SIM by determining that the first number of signal emitters is greater than the second number of signal emitters.

19. The UE of claim 18, wherein the first uncertainty value and the second uncertainty value each comprise at least one of a location uncertainty of a location of a respective signal emitter or a timing uncertainty of a time of arrival of a respective signal.

20. The UE of claim 13, wherein the processor is further configured to:
determine a first indication of the quality of the first positioning assistance data; and
determine a second indication of the quality of the second positioning assistance data.

21. The UE of claim 13, wherein the processor is further configured to receive, from a server, a first indication of the quality of the first positioning assistance data and a second indication of the quality of the second positioning assistance data.

22. The UE of claim 13, wherein the processor is configured to perform the action using the first SIM by placing a phone call using the first SIM.

23. The UE of claim 22, wherein the processor is configured to place the phone call using the first SIM in response to receiving an indication from a user to place an emergency call.

24. The UE of claim 13, wherein the processor is configured to perform the action using the first SIM by measuring, using the first positioning assistance data, a parameter of each signal of a plurality of positioning signals for use in determining a location of the UE, the plurality of positioning signals being received from a respective signal emitter of a plurality of signal emitters.

25. A user equipment (UE) comprising:
a first subscriber identifying means associated with a first network;
a second subscriber identifying means associated with a second network;
a communicating means for communicating with the first network using the first subscriber identifying means and the second network using the second subscriber identifying means;
a determining means for determining that a quality of first positioning assistance data associated with the first subscriber identifying means is greater than a quality of second positioning assistance data associated with the second subscriber identifying means; and
an action performing means for performing an action using the first subscriber identifying means in response to determining that the quality of first positioning assistance data associated with the first subscriber identifying means is greater than the quality of second positioning assistance data associated with the second subscriber identifying means.

26. The UE of claim 25, wherein the determining means are further for comparing a first number of positioning techniques for which information is included in the first positioning assistance data and a second number of positioning techniques for which information is included in the second positioning assistance data.

27. The UE of claim 25, wherein the determining means are further for comparing a first number of signal emitters for which information is included in the first positioning assistance data and a second number of signal emitters for which information is included in the second positioning assistance data.

28. A non-transitory, processor-readable storage medium comprising processor-readable instructions configured to cause a processor of a user equipment (UE) to:
determine that a quality of first positioning assistance data associated with a first subscriber identity module (SIM) of the UE is greater than a quality of second positioning assistance data associated with a second SIM of the UE; and
perform an action using the first SIM in response to determining that the quality of first positioning assistance data associated with the first SIM is greater than the quality of second positioning assistance data associated with the second SIM.

29. The non-transitory, processor-readable storage medium of claim 28, wherein the instructions configured to cause the processor to determine that a quality of first positioning assistance data associated with a first subscriber identity module (SIM) of the UE is greater than a quality of second positioning assistance data associated with a second SIM of the UE comprise instructions configured to cause the processor to compare a first number of positioning techniques for which information is included in the first positioning assistance data and a second number of positioning techniques for which information is included in the second positioning assistance data.

30. The non-transitory, processor-readable storage medium of claim 28, wherein the instructions configured to cause the processor to determine that a quality of first positioning assistance data associated with a first subscriber identity module (SIM) of the UE is greater than a quality of second positioning assistance data associated with a second SIM of the UE comprise instructions configured to cause the processor to compare the first number of signal emitters for which information is included in the first positioning assistance data and a second number of signal emitters for which information is included in the second positioning assistance data.
